(19) United States
(12) Patent Application Publication
(10) Pub. No.: US 2021/0137150 A1
(43) Pub. Date: May 13, 2021

(54) FOOD COATING APPARATUS AND FOOD PRODUCTION METHOD

(71) Applicant: NICHIREI FOODS INC., Tokyo-to (JP)

(72) Inventors: Yoshito FUJIMORI, Chiba-shi (JP); Hirokazu CHUKYO, Chiba-shi (JP); Jiro KITAMURA, Chiba-shi (JP); Shunichi WATANABE, Chiba-shi (JP); Nao SATOU, Chiba-shi (JP)

(73) Assignee: Nichirei Foods Inc., Tokyo-to (JP)

(21) Appl. No.: 17/042,288

(22) PCT Filed: Mar. 6, 2019
(86) PCT No.: PCT/JP2019/008739

§ 371 Date: Sep. 28, 2020

(30) Foreign Application Priority Data
Mar. 29, 2018 (JP) 2018-064601

(51) Int. Cl. A23P 20/15; B65G 49/04

(52) U.S. Cl. CPC A23P 20/15; B65G 2201/0202; B65G 49/04

(57) ABSTRACT

The invention provides a food coating apparatus and a food production method in which an impact applied when a food material is put can be reduced, misalignment or deformation of a food material can be suppressed, and even a soft food material, an easily-crumbled food material, or the like can be efficiently coated. A food coating apparatus comprises: a flow channel through which a liquid coating material flows; a conveyor to be immersed in the liquid coating material and to make the liquid coating material to flow in a travel direction, the conveyor being arranged on an upper side of a bottom surface of the flow channel; a drive device configured to drive the conveyor; and a putting device configured to put a food product, wherein the conveyor is immersed in the liquid coating material at a putting position where the putting device puts the food product, and the food product is conveyed and coated with the liquid coating material in the flow channel in a state where the food product is supported by the conveyor or is supported by the liquid coating material that is flowing.

### CROSS REFERENCE TO RELATED APPLICATIONS

This application is based upon and claims the benefit of priority from the prior Japanese Patent Application No. 2018-064601, filed on Mar. 29, 2018, the entire contents of which are incorporated herein by reference.

### FIELD

The present invention relates to a food coating apparatus and a food production method.

### BACKGROUND

In food production, a step of coating (attaching) various food materials with a liquid such as a batter or powder is performed. Here, it is necessary to coat food materials having various physical properties. For example, in order to realize a food product with a soft and good texture, a technique of coating a food material having a high water content, a food material having bubbles, a food material that is soft and easily deformed, a food material having a cavity, an easily-crumbled food material having low adhesiveness is required. In addition, recently, a high-speed food processing device or cooking device has developed, and thus the production line of food products has become more efficient. Therefore, in order to prevent a coating step from becoming a bottleneck in the whole production step, it is required to develop a technique of efficiently coating a food product with a batter.

Japanese Patent Laid-Open No. 4-234952 discloses a device in which a food material is wholly immersed with a batter. In this case, a food product floats in a batter when put thereinto. Misalignment of food materials or adhesion between food materials may occur. In addition, a food material may be deformed by a hold-down conveyor. Japanese Patent Publication No. 1-39747 discloses a device in which a batter is poured from above a food material. In order to coat the entire surface of a food material with a batter by pouring the batter only from above the food material, it is necessary to pour a large amount of the batter. In this case, the food material may be flown away by the batter.

In addition, Japanese Patent Publication No. 1-39747 also discloses a device in which the immersion method and the method of pouring a batter from above a food material are combined. When a food material is put into a conveyor from a previous step, crumbling or attachment to the conveyor may occur. In addition, when a batter is poured to a food material from above, deformation or misalignment may occur. Japanese Patent Laid-Open No. 51-27781 discloses a fryer in which a food material is put into oil from a molding machine. Since the food material floats in the oil, there is a risk of misalignment.

### PRIOR ART DOCUMENT

[Patent Document 1] Japanese Patent Publication NO. 4-234952

[Patent Document 2] Japanese Patent Publication NO. 1-39747

[Patent Document 3] Japanese Patent Publication NO. 51-27781

### PROBLEM TO BE SOLVED

When a soft food material or an easily-crumbled food material is coated using the device in the related art, crumbling or attachment to a conveyor occurs, which causes deterioration in quality or food material loss. In addition, there is a risk that food materials arranged on a conveyor are misaligned to cause adhesion between food materials or deformation. In order to avoid the risk, it is necessary to provide a large distance between food materials on the conveyor, it is difficult to increase the arrangement density of food products.

The invention has been made in consideration of the circumstances and provides a food coating apparatus and a food production method in which an impact applied when a food material is put can be reduced, misalignment or deformation of a food material can be suppressed, and even a soft food material, an easily-crumbled food material, or the like can be efficiently coated.

### SUMMARY

According to the present invention, a food coating apparatus comprises: a flow channel through which a liquid coating material flows; a conveyor to be immersed in the liquid coating material and to make the liquid coating material to flow in a travel direction, the conveyor being arranged on an upper side of a bottom surface of the flow channel; a drive device configured to drive the conveyor; and a putting device configured to put a food product, wherein the conveyor is immersed in the liquid coating material at a putting position where the putting device puts the food product, and the food product is conveyed and coated with the liquid coating material in the flow channel in a state where the food product is supported by the conveyor or is supported by the liquid coating material that is flowing.

### BRIEF DESCRIPTION OF THE DRAWINGS

FIG. 1 is a diagram showing a first configuration example of the entire food coating apparatus.

FIG. 2 is a diagram showing a second configuration example of the entire food coating apparatus.

FIG. 3 is a diagram showing a state where a food product is put on a conveyor when a coating material is not present.

FIG. 4 is a diagram showing an example of deformation or fracture when the food product is put on the conveyor.

FIG. 5 is a perspective view showing a flow channel relating to the food coating apparatus.

FIG. 6 is a plan view showing the flow channel relating to the food coating apparatus.

FIG. 7 is a cross-sectional view showing the flow channel relating to the food coating apparatus.

FIG. 8 is a diagram showing a state where the food product is put into the flow channel when a batter is present.

FIG. 9 is a cross-sectional view showing an example where the liquid level of the batter is adjusted to be higher than the food product.

FIG. 10 is a cross-sectional view showing an example where the liquid level of the batter is adjusted to be lower than the food product.

FIG. 11 is a high-density arrangement example of food products in the food coating apparatus.

FIG. 12 is a cross-sectional view showing an example of a configuration of the food coating apparatus.

FIG. 13 is a flowchart showing an example of a process of controlling a height of the liquid level of the batter.

FIG. 14 is a diagram showing an example of a food coating apparatus according to a second embodiment.

FIG. 15 is a diagram showing an example of a food coating apparatus according to a third embodiment.

FIG. 16 is a diagram showing an example of a food coating apparatus according to a fourth embodiment.

### DETAILED DESCRIPTION

Hereinafter, embodiments of the invention will be described with reference to the drawings. In addition, in the drawings, the same components are represented by the same reference numerals, and the description thereof will not be repeated.

### First Embodiment

FIGS. 1 and 2 are diagram showing configuration examples of the entire food coating apparatus. Hereinafter, the summary of the food coating apparatus according to the invention will be described.

In any step of food production in the food coating apparatus 1, a step of coating a food material with a predetermined coating material having fluidity can be applied. Hereinafter, in the coating step, an example where a food product (food material) is immersed in a batter will be described. However, the kinds of the food material and the coating material are not limited. For example, a sauce (seasoning) as the coating material may be added to a rice ball, a dumpling, or the like using the food coating apparatus. The food material may be any one of a food product for a human, a food product for an animal, a health food product, or a food material used for production of an oral medicine. The coating material may be a sugar coating, a starch, an oil and fat, a seasoning, a spice, a chocolate, a cream, or a mixture of a plurality of materials, for example.

In the following description, all of a food material that is a raw material of a food product, a food product or a food material that is in the middle of a production step, and a food product that is cooked to be edible will be collectively referred to as “food product”. The food product is coated with a liquid coating material in the coating step. The entire surface of the food product may be coated with the liquid coating material, or a part of the surface of the food product may be coated with the liquid coating material. The liquid coating material may penetrate into the food product. Hereinafter, the liquid coating material will be referred to as “liquid coating material”. The liquid coating material only has to be liquid in the coating step and is not necessarily liquid in a subsequent step or after the production of the food product.

The food coating apparatus 1 shown in FIGS. 1 and 2 are in the coating step between a previous step and a next step. In the food coating apparatus 1, a food product such as a meat, a processed food product, a boiled fish paste, a bread, a tofu, a rice cake, a confectionery, or a vegetable is put in the previous step and is coated with a batter in the coating step. The food product that is coated with the batter is cooked or processed in the next step.

The batter is an example of the above-described liquid coating material and is a liquid including a starch and the like used as a binding agent during the production or cooking of the food product. In general, the batter is used to improve the adhesiveness of the coating material, to maintain the shape, or to improve water retention ability or a texture. However, the usage of the batter is not particularly limited. In addition, the batter may include a salt or a protein and may have any composition.

In the invention, liquid coating materials having various properties can be used. For example, the liquid coating material that is a foam in which gas is dispersed in a liquid, an emulsion in which a plurality of liquids are suspended, a suspension in which solid particles are dispersed in a liquid can be used. As long as the liquid coating material has fluidity, the liquid coating material may be a pure liquid or a mixture of a liquid and a solid. For example, a mixture in which particles or a solid material is mixed with a liquid may be used as the liquid coating material. Particles or a solid material may have a size that is recognizable or may be small. Examples of the particles or the solid material that is mixed with a liquid include a sugar, a salt, various spices, katsuobushi, a laver, and a nut, but the kind thereof is not particularly limited. In addition, the size of viscosity of the liquid coating material is not particularly limited.

The kinds of the previous step and the next step of the coating step in the food coating apparatus are not particularly limited. For example, in the next step of the coating step, bread crumbs may be attached to the food product, or the food material may be rapidly cooled or dried. In addition, in the previous step of the coating step, a step of cutting the food product corresponding to one meal from a part of a large raw material may be performed. A step of molding, heating, seasoning, oil-frying, or the like of the food material may be performed.

In the first embodiment, a food coating apparatus according to a first configuration example and a food coating apparatus according to a second configuration example will be described. Hereinafter, first, the food coating apparatus according to the first configuration example will be described.

### First Configuration Example

FIG. 1 shows the first configuration example of the food coating apparatus. As shown in the upper part of FIG. 1, the food coating apparatus 1 according to the first configuration example includes a flow channel 2, a conveyance device 3, a pipe device 4, and a batter bath 20. In the lower part of FIG. 1, a cross-sectional view taken along a y-z surface of the food coating apparatus 1 through which line BB′ passes. Hereinafter, the description will be made with reference to FIG. 1.

The flow channel 2 is a structure through which the liquid coating material flows. The flow channel 2 in FIG. 1 is arranged inside the batter bath 20. As shown in the lower part of FIG. 1, the bottom portion of the flow channel 2 has a height in the vicinity of a top surface of the batter (liquid coating material) stored in the batter bath, and is supported such that an upper side of a bottom surface of the flow channel 2 is lower than the top surface (liquid level) of the batter (liquid coating material) stored in the batter bath. A conveyor is provided on the upper side of the bottom surface of the flow channel 2. The conveyor is immersed in the batter (liquid coating material), and the batter (liquid coating material) flows in a travel direction. Since the conveyor in FIG. 1 is driven in an x-axis positive direction, the batter (liquid coating material) is made to flow in the x-axis positive direction.

Hereinafter, on the upper side of the bottom surface of the flow channel, an end portion in the travel direction of the conveyor, that is, in the direction in which the liquid coating material flows will be referred to as “downstream position of the flow channel”. On the other hand, on the upper side of the bottom surface of the flow channel, an end portion in a direction opposite to the travel direction of the conveyor, that is, in a direction opposite to the direction in which the liquid coating material flows will be referred to as “upstream position of the flow channel”. In the example of FIG. 1, the downstream position and the upstream position of the flow channel are shown.

The conveyance device 3 conveys the food product F using the above-described conveyor. The conveyance device 3 includes the conveyor, a structure that supports the conveyor to be movable, and a drive device that drives the conveyor. Examples of the drive device that drives the conveyor include an electric motor, an internal combustion engine, and a rotary machine using steam, but the method of the drive device is not particularly limited.

A putting device puts a food product F to a putting position where the conveyor is immersed in the batter (liquid coating material). In the flow channel 2, the food product F is conveyed in a state where the food product F is supported by the conveyor or is supported by the batter (liquid coating material) that is flowing. The food product F to be conveyed is coated with the batter (liquid coating material). The details of the putting device will be described below. The food product F having undergone the coating step is conveyed to the next step by the conveyance device 3.

In the food coating apparatus 1 according to the first configuration example, when the food product F is put, at least a part of the food product F is immersed in the batter (liquid coating material). At a position positioned in the travel direction of the conveyor with respect to the putting position, the batter is poured to the food product F from above by a pouring device. Therefore, the entire surface of the food product F is coated with the batter (liquid coating material). The food coating apparatus in FIG. 1 includes one pouring device. However, the food coating apparatus may include a plurality of pouring devices. A configuration example of the food coating apparatus including the plurality of pouring devices will be described below.

The pipe device 4 pumps up the batter (liquid coating material) stored in the batter bath 20 using a pump and supplies the batter (liquid coating material) to the pouring device. The pipe device 4 is an example of a circulation mechanism that makes the batter (liquid coating material) flow in the direction opposite to the travel direction of the conveyor.

The food coating apparatus according to the invention is not necessarily include the pouring device and the pipe device 4. When the batter (liquid coating material) is not poured to the food product F that is being conveyed from above the food product F, a configuration not including the pouring device and the pipe device 4 may be used. That is, the food coating apparatus is not necessarily include the pouring device or the circulation mechanism that circulates the batter.

Next, a second configuration example of the food coating apparatus according to the invention will be described.

### Second Configuration Example

The bottom portion of the flow channel according to the first configuration example has the height in the vicinity of the top surface of the batter (liquid coating material) stored in the batter bath, and the upper side of the bottom surface of the flow channel 2 is lower than the top surface of the batter (liquid coating material) stored in the batter bath. However, the bottom portion of the flow channel in the food coating apparatus may be distant from the top surface of the batter (liquid coating material) stored in the batter bath. In the food coating apparatus according to the second configuration example, the bottom portion of the flow channel is distant from the top surface of the batter (liquid coating material) stored in the batter bath.

That is, the first configuration example and the second configuration example are different from each other in a positional relationship between the bottom portion of the flow channel and the top surface of the batter (liquid coating material) stored in the batter bath. Depending on the amount of the batter (liquid coating material) stored in the batter bath, the food coating apparatus may switch between the first configuration example and the second configuration example. For example, by increasing the amount of the batter (liquid coating material) stored in the batter bath, the first configuration example may be realized, and by decreasing the amount of the batter (liquid coating material) stored in the batter bath, the second configuration example may be realized. In addition, by using a food coating apparatus in which the flow channel 2 is movably supported and a mechanism that changes a relative height of the flow channel to the batter bath, the food coating apparatus may switch between the first configuration example and the second configuration example.

FIG. 2 shows the food coating apparatus according to the second configuration example. The food coating apparatus 1 shown in FIG. 2 includes the flow channel 2, the conveyance device 3, the pipe device 4, and the batter bath 20.

In the flow channel 2 in FIG. 2, the conveyor moves in the x-axis positive direction. On the conveyor, a flow of the batter (liquid coating material) is formed in the substantially the same direction as a movement direction of the conveyor. The conveyor is provided on the upper side of the bottom surface of the flow channel. The food product F having undergone the process in the previous step is put into the liquid coating material in which the conveyor is immersed. At this time, at least a part of the food product F including the bottom portion of the food product F is immersed in (coated with) the batter.

The food product F is conveyed in x-axis positive direction of the flow channel 2 in the state where the food product F is supported by the conveyor or is supported by the batter (liquid coating material) that is flowing. At a position in the travel direction of the conveyor with respect to the putting position of the food product F, a second pouring device pours the batter to the conveyor from above (y-axis positive side) the conveyor. The batter is poured from above the food product F that is being conveyed by the conveyor. Therefore, the entire surface of the food product F can be coated with the batter. In the second pouring device of FIG. 2, the batter (liquid coating material) is poured in a section where the conveyor is provided in the flow channel 2. However, the second pouring device does not necessarily pour the batter (liquid coating material) in the section where the conveyor is provided in the flow channel 2. As described below, the second pouring device may pour the batter (liquid coating material) at a position of the conveyor in the x-axis positive direction with respect to the downstream position of the flow channel 2.

At this time, a part of the food product F is supported from below while being immersed in the batter. Therefore, even when the batter is poured from above, misalignment or crumbling does not occur. In the flow channel 2, the food product F can be conveyed in a state where the food product F is supported irrespective of the presence of the batter (liquid coating material).

Hereinafter, an example where the food product F is conveyed in a state where the food product F is supported by the conveyor will be described. However, the food product F may be conveyed in a state where the food product F is supported by the liquid coating material that is flowing. For example, the bottom surface of the food product F is not necessarily in contact with the conveyor, and only a part of the bottom surface of the food product F may be in contact with the conveyor. In addition, a layer of the liquid coating material may be present between the bottom surface of the food product F that is being conveyed and the conveyor.

In the food coating apparatus according to the invention, a uniform flow of the liquid coating material is formed in substantially the same direction as the movement direction of the conveyor belt in the flow channel. In addition, the liquid coating material has a fixed viscosity. Accordingly, even when the food product F floats in the liquid coating material, the food product F is supported by a uniform flow of the liquid coating material having viscosity. Therefore, misalignment is suppressed. That is, in the food coating apparatus according to the invention, it is preferable that the food product F is conveyed in a state where the food product F is supported by the conveyor. However, the food product F that floats in the liquid coating material does not interfere the use of the food coating apparatus according to the invention.

In a food coating apparatus in the related art, in order to suppress the misalignment of the food product, the food product F is held down from above using a hold-down conveyor. When the hold-down conveyor is used, the attachment, fracture, or crumbling of the food product F, the peeling of the coating material, or the like may occur. In the food coating apparatus according to the invention, the food product F is conveyed while being supported. Therefore, even when the hold-down conveyor or the like that holds down the food product from above is not used, the misalignment of the food product can be suppressed.

As in the first configuration example, the conveyance device 3 conveys the food product F using the conveyor.

Since the batter (liquid coating material) is present on the conveyor, a flow of the batter is formed in substantially the same direction as the movement direction of the conveyor due to viscosity. The conveyor of the conveyance device 3 that is provided substantially horizontally in the flow channel 2 rises with a slope after passing the flow channel 2. Due to the rising slope, the food product F on the conveyor is moved to a position higher than the water level of the batter in the flow channel 2. On the other hand, the batter flows down to the batter bath 20 that is provided below the downstream position of the flow channel 2.

The conveyor of the conveyance device 3 becomes substantially horizontal again by moving toward the x-axis positive direction. A terminal of the conveyance device 3 (end portion on the x-direction positive side) is positioned in the vicinity of a device relating to the next step. The food product F that is conveyed up to the terminal of the conveyance device 3 is put on the device relating to the next step. Examples of the device relating to the next step include a device that performs heating (for example, boiling, grilling, or oil-frying), cooling, drying, seasoning, flavoring, breading, cutting, packaging, or the like. The kind of the device is not particularly limited.

The pipe device 4 is an example of a circulation mechanism that makes the liquid coating material flow in the direction opposite to the travel direction of the conveyor. The pipe device includes, for example, a pump or a pipe. The pipe device may further include a tank that stores the batter. The pipe in the pipe device 4 pumps up the batter stored in the batter bath using the pump and supplies the batter using the pouring device provided on the flow channel 2. In the example of FIG. 2, a first pouring device that pours the liquid coating material into the flow channel at a position positioned in a direction opposite to the travel direction of the conveyor with respect to the putting position of the food product is provided. On the other hand, a second pouring device that pours the liquid coating material from above the conveyor at a position positioned in the travel direction of the conveyor with respect to the putting position of the food product is provided.

As the circulation mechanism, a mechanism other than a combination of the pump and the pipe can be used. For example, another flow channel through which the liquid coating material flows in a direction opposite to the travel direction of the conveyor may be formed below the flow channel or on a side surface thereof. In addition, using a rotary machine such as a conveyor, a water turbine, or a screw of a return channel, the liquid coating material may be made to flow in a direction opposite to the travel direction of the conveyor.

The batter bath 20 collects the batter that flows down from the downstream position of the flow channel 2 in a region below the flow channel 2. Since the batter bath 20 is connected to the pipe of the pipe device 4, the collected batter can be supplied to the flow channel 2 again.

Before describing the details of the food coating apparatus according to the invention, problems relating to the coating of the food product in the related art will be described.

FIG. 3 is a diagram showing a state where a food product is put on a conveyor when a buffer is not present. In FIG. 3, since the food product F is directly put on a conveyor 20c, a lower shape of the food product F is distorted and divided into a plurality of fragments. In the example of FIG. 3, a net conveyor (mesh conveyor) in which a mesh-shaped net belt is used is shown, but the kind of the conveyor is not particularly limited. A belt conveyor not having an opening may be used, a mesh conveyor formed of a metal or a resin may be used, or a roller conveyor may be used. In addition, a conveyor formed of a rubber, a resin, a woven fabric, or a felt, or Teflon may be used. The conveyor may have a mesh shape or a shape other than a mesh shape. In order to easily attach the liquid coating material to the lower surface of the food product F, it is preferable that a mesh-shaped net conveyor (mesh conveyor) is used.

The food product handled in the food coating step does not always have a sufficient elasticity or hardness. Accordingly, when a food product that is processed to have a predetermined size and a predetermined shape in the previous step is put on the conveyor, the fracture, deformation, alteration, or damage of the food product occurs, which leads to food material loss, quality deterioration, an increase in the number of steps relating to defective product removal.

On the other hand, FIG. 4 is a diagram showing an example of deformation or fracture when a food product is directly put on the conveyor. In FIG. 4, the food product is put from a food putting device that is arranged above the conveyor (y-axis positive side). Since the conveyor moves in the x-axis positive direction, the food product put on the conveyor also moves in the x-axis positive direction. The put food product is sequentially conveyed in the next step. In the example of FIG. 4, when the food product is put, crushing, deformation, or crumbling occurs. In addition, when a net conveyor is used, the biting of the food product into a net also occurs. In this case, the yield of the food product is poor, and it is necessary to remove a food product that cannot be used as a product through a manual operation or the like.

Recently, along with diversification of diet, an increase in needs for a food product with a soft and good texture, and the like, for example, a technique of processing a food product having a high water content, a brittle and easily-crumbled food product, a porous food product, a gelatinous food, and the like is required. Therefore, in the coating step, it is required to coat the food product having various properties with a desired liquid coating material while maintaining the shape, the size, and the quality.

Next, the details of the flow channel relating to the food coating apparatus according to the invention will be described with reference to the drawings. In the food coating apparatus according to the invention, a food product that is soft and easily deformed, an easily-crumbled food product, or the like can be coated without being deformed or fractured.

FIG. 5 is a perspective view showing the flow channel relating to the food coating apparatus. FIG. 6 is a plan view showing the flow channel relating to the food coating apparatus. In FIGS. 5 and 6, a white arrow shows a direction of a flow of the batter in flow channel 2. On the other hand, a fine arrow shows a direction of the movement of a conveyor 22.

The flow channel 2 is a structure including a bottom plate 23, a side wall 23a, and a side wall 23b. The conveyor 22 is provided on a top surface of bottom plate 23. The side walls 23a and 23b are provided along an outer periphery of the bottom plate 23. The side wall 23a is formed on both side surfaces in a length (x-axis) direction of the bottom plate 23. The side wall 23b is formed on a side in a width direction of the bottom plate 23 corresponding to the upstream position of the flow channel 2. On the other hand, a side wall is not formed in an edge portion 61 in the width direction of the bottom plate 23 corresponding to the downstream position of the flow channel 2, and the edge portion 61 is opened. A range of the flow channel 2 surrounded by the side walls 23a and 23b and the edge portion 61 functions as a flow channel of the batter (liquid coating material).

In the example of FIGS. 5 and 6, the opened edge portion 61 of the bottom plate 23 is a single outlet from which the batter poured to the flow channel 2 from a first nozzle 26 corresponding to the first pouring device and a pouring container 27 corresponding to the second pouring device can flows out. The drive device drives the conveyor 22 in the x-axis positive direction, that is, in a direction from the upstream position of the flow channel 2 toward the opened downstream position (edge portion 61). A flow of the batter (liquid coating material) in the flow channel 2 in contact with the surface of the conveyor 22 is formed in substantially the same direction of the conveyor 22 as the movement direction of the conveyor 22, that is, in a direction from the upstream position (x-axis negative side) toward the downstream position (edge portion 61) of the flow channel 2 due to viscosity.

The speed of the flow of the batter in the flow channel 2 and the height (the height of the liquid level) of the top surface of the batter from the conveyor 22 can be adjusted based on the amount of the batter poured to the flow channel 2 from the first nozzle 26 (first pouring device) and the pouring container 27 (second pouring device) and the moving speed of the conveyor 22. The bottom plate 23 (the flow channel according to the embodiment) of the flow channel 2 is arranged substantially horizontally, that is, to match a z-x plane of FIG. 5. As a result, a uniform and calm flow having a slow flow rate can be formed in the flow channel 2, erosion of a soft food product caused by the flow of the batter, misalignment, or deformation can be minimized.

In the vicinity of the edge portion 61 of the flow channel 2, a holder 62 that extends from the side wall 23a on both sides to the inside of the flow channel 2 is provided. The conveyor 22 moves in a state where the conveyor 22 is interposed between the holder 62 and the bottom plate 23. Due to the holder 62, the conveyor 22 rises with a slope from an intermediate section. Here, the rising slope represents that the value of the height in the y-axis positive direction increases as the conveyor 22 moves in the x-axis positive direction. The example where a starting point of the portion of the conveyor that rises with a slope is present at the downstream position (the edge portion 61 of the bottom plate 23) of the flow channel 2 has been described. The starting point of the rising slope may be present at a position in a direction opposite to the travel direction of the conveyor with respect to the edge portion 61 of the bottom plate 23.

As described above, the batter flows down at the downstream position of the flow channel 2. In the embodiment, the batter that flows down from the flow channel 2 is collected by the batter bath 20. However, a destination to which the batter flows is not particularly limited. For example, in the vicinity of the downstream position of the flow channel, a hose or the like may be provided to collect the batter. For example, the batter that flows down from the edge portion 61 of the bottom plate 23 may flow through another flow channel. When the starting point of the section 22a that rises with a slope is set to a position in a direction opposite to the travel direction of the conveyor with respect to the edge portion 61 of the bottom plate 23, the food product F that is being conveyed by the conveyor can be separated from airborne droplets of the batter (liquid coating material) that flows down.

When the conveyor is a net conveyor having mesh-shaped holes, the batter can be made to flow down from the mesh-shaped holes of the net conveyor at the downstream position (edge portion 61) of the flow channel 2, and can also be made to flow down from a gap between the conveyor 22 and the side wall 23a. For example, when the conveyor is a rubber belt not having mesh-shaped holes, the batter flows down from the gap between the conveyor 22 and the side wall 23a to the batter bath 20 at the downstream position (edge portion 61) of the flow channel 2. Accordingly, when a net conveyor is used as the conveyor 22, the batter can be made to easily flow down at the downstream position of the flow channel 2.

When the conveyor is a net conveyor having a mesh-shaped holes, in the section 22a, redundant batter attached to the food product F or the conveyor can be made to flow down from the mesh-shaped holes of the conveyor 22. In order to improve the effect of removing the redundant batter, vibration may be added to the conveyor 22 in the section 22a. In order to collect the batter that flows down by shaking, the batter bath 20 may be arranged below the section 22a.

It is not necessary to provide the rising slope to the conveyor as shown in FIG. 5. However, it is preferable that the food product F coated in the flow channel is conveyed through a rising slope because the redundant batter attached to the conveyor and the food product F can be removed and prevented from being incorporated in the next step.

The bottom plate 23, the side walls 23a and 23b, the holder 62, the first pouring device, and the second pouring device can be formed of a metal such as stainless steel, aluminum, or titanium but may be formed of a resin, an enamel, or glass without any particular limitation in material.

Hereinafter, each of the components in the flow channel 2 will be described with reference to FIGS. 5 and 6.

The first nozzle 26 is an example of the first pouring device that pours the liquid coating material into the flow channel 2 at a position positioned in a direction opposite to the travel direction of the conveyor with respect to the putting position of the food product in the flow channel 2. FIG. 5 shows the nozzle in which an opening having an elongated substantially rectangular shape is provided along the side wall 23b in the width direction of the flow channel 2. However, the shape of this nozzle is merely an example of the first pouring device, and a nozzle having a shape different from the above-described shape may be used.

The first pouring device is not particularly limited in installation position as long as the first pouring device pours the liquid coating material to the flow channel 2. Accordingly, the first pouring device is not necessarily provided in the vicinity of the upstream position of the flow channel 2. The installation position of the first pouring device may be different from that of the example of FIGS. 5 and 6. For example, as shown in FIGS. 5 and 6, the first pouring device may be provided at the side wall 23a in the length direction without being provided along the side wall 23b at the upstream position. In addition, the first pouring device may pour the batter at a plurality of different angles. In addition, a plurality of first pouring devices may be provided instead of providing the single first pouring device. In order to prevent the formation of a complex flow in the flow channel 2 and to form a uniform flow, it is preferable that the first pouring device is provided at a position in a direction opposite to the travel direction of the conveyor with respect to the putting position of the food product.

A putting position 10a corresponds to the lower side (y-axis negative side) of the food putting device 10. The food putting device 10 puts the food product on the batter 21 (liquid coating material) in which the conveyor 22 is immersed. The food putting device 10 is an example of the putting device in the food coating apparatus. In the example of FIGS. 5 and 6, at the putting position 10a, five food products are put (arranged) in the width direction of the conveyor 22. However, the number of food products to be put may be different from 5.

The kind or configuration of the food putting device 10 to be used is not particularly limited. For example, the food product may be arranged at the putting position 10a by a robot hand, or may be made to flow down from a food molding machine or another conveyance device (for example, another conveyor) at the putting position 10a That is, a method of arranging the food product at the putting position 10a is not particularly limited.

The molding machine may be a stamping type molding machine, a molding machine that extrudes the food material, or a molding machine that rolls the food material, and the method of molding is not particularly limited. In addition, the size and shape of the food product to be molded is not particularly limited. Examples of the food product and the food material to be molded include a fish, a meat, a vegetable, a fruit, a cooked rice, a bread, a cake, a noodle, a croquette, a hamburger, a meatball, a Japanese confectionery, a western confectionery, and a dumpling, but the kind thereof is not particularly limited.

When the putting device of the food coating apparatus is a molding machine, the food product flows down by stamping or cutting such that an impact is unavoidably applied to the food product. Therefore, it can be said that, the food coating apparatus according to the invention is preferable to use in the step of coating the food product stamped from the molding machine.

At a position in the x-axis positive direction with respect to the putting position 10a, a line segment AA′ in the width direction (z-axis direction) of the flow channel 2 is shown. FIG. 7 is a cross-sectional view of the flow channel 2 taken along line segment AA′. As shown in FIG. 7, the side wall 23a and the bottom plate 23 form a flow channel of the batter (liquid coating material). The conveyor 22 is provided above the bottom plate 23. In the example of FIG. 7, the conveyor 22 is in contact with the upper surface of the bottom plate 23. However, a gap may be present between the conveyor 22 and the bottom plate 23. In addition, a material having cushioning properties such as a rubber, a polyethylene, or a bubble wrap may be arranged between the conveyor 22 and the bottom plate 23.

The food product F is arranged on the conveyor 22. In the example of FIG. 7, a height hₗ of the liquid level of the batter 21 is lower than a height h_{f} of a top end of the food product F from the conveyor 22. Therefore, a part of the food product F is immersed in the batter 21. In addition, the bottom surface of the food product F is in contact with the conveyor 22 and does not float in the batter 21.

Accordingly, at the putting position 10a, the batter 21 functions as a buffer when the food product F is put and prevents the deformation or fracture of the food product. In addition, the food product F is not directly put on the conveyor 22. Therefore, the attachment of the food product F to the conveyor 22 is suppressed, and the food product F is easily peeled off from the conveyor 22. In addition, crumbling caused by a collision between the food product F and the conveyor can be alleviated.

FIG. 8 is a diagram showing a state where the food product is put into the flow channel when the batter is present. Unlike the case of FIG. 3, the batter 21 (liquid coating material) is present as a buffer, and thus the deformation or fracture of the food product F is prevented. In FIG. 8, the bottom surface of the food product F is not in contact with the conveyor 20c. As in the example of FIG. 8, in the food coating apparatus, the food product F may be conveyed in a state where the food product F is supported by the liquid coating material that is flowing.

Hereinafter, the description will be made referring to FIGS. 5 and 6 again.

The pouring container 27 as the second pouring device is provided above (y-axis positive direction) the position positioned in the travel direction of the conveyor with respect to the putting position 10a of the flow channel 2. The pouring container 27 temporarily receives the batter that is poured from above (y-axis positive direction) the pouring container 27. The batter that flows out from the pouring container 27 flows down to the flow channel 2 from openings 27a and 27b that are provided in the width direction (z-axis direction) of the flow channel 2. As a result, the batter flows down in a waterfall manner in the width direction of the flow channel 2. Therefore, top portions of a plurality of food products F arranged in the width direction of the conveyor 22 can be coated with the batter 21 (liquid coating material).

The batter that flows down from the opening 27a (first opening) is poured to the food product F that is conveyed in the x-axis positive direction (the travel direction of the conveyor) from above. Further, at a position in the x-axis positive direction, the batter that flows down from the opening 27b (second opening) is poured to the food product F from above. Therefore, even when an uneven portion or the like is present in the food product F, the surface of the food product F can be fully coated with the batter.

The number of times the batter is poured in the width direction in the second pouring device may be different from that of the example of FIGS. 5 and 6. The number of times that the batter is poured in the width direction in the second pouring device or the pouring amount of the batter in the second pouring device can be determined based on the size of the area of a portion of the food product F that is not coated or the complexity of the shape. That is, the structure and shape of the second pouring device are not particularly limited as long as the batter (liquid coating material) can be poured to the food product in the second pouring device. For example, the batter (liquid coating material) may be poured into the flow channel directly without passing through the pouring container unlike the example of FIG. 2. In addition, the number of second pouring devices may be one or plural. In particular, when the liquid coating material is likely to be scattered from the food product F due to a low viscosity or when the moving speed of the conveyor is high, the surface of the food product F can be fully coated by using a plurality of second pouring devices.

In the second pouring device, the batter is poured to the food product F that is being conveyed from two positions after being temporarily received by the pouring container 27 instead of being poured directly from the nozzle. Therefore, a hydraulic pressure or an impact of the batter applied to the food product F can be alleviated. As a result, the deformation or fracture of a soft food product or a brittle food product can be prevented.

The structure of the second pouring device (pouring container 27) in FIGS. 5 and 6 is merely exemplary, and a second pouring device having a structure different from the above-described structure may be used. For example, a shower nozzle that pours the batter to the food product F may be used, or a spray nozzle that sprays the batter to the food product F may be used. In addition, an angle at which the batter is poured to the food product F in the second pouring device is not particularly limited. For example, the batter may be poured from the side surface of the food product F, or may be poured from an obliquely upward direction of the food product F.

When it is not necessary to attach the batter to the entire surface of the food product F or when the entire surface of the food product F can be immersed with only the batter 21 of the flow channel 2, the second pouring device may be removed.

In the example of FIGS. 5 and 6, the direction in which the conveyor arranged above the bottom surface of the flow channel 2 moves is substantially fixed. However, the direction in which the conveyor moves is not necessarily fixed. For example, using a curved conveyor, the food product F may be conveyed while changing the direction. In addition, a conveyor including a linear section and a curved section may be used.

The width of the flow channel 2 shown in FIGS. 5 and 6 in the z-axis direction is substantially fixed. However, the width of the flow channel 2 is not necessarily substantially fixed. For example, a flow channel in which the width decreases in the x-axis positive direction (the travel direction of the conveyor) may be used. As a result, a flow channel in which the depth of the batter (liquid coating material) increases in the x-axis positive direction (the travel direction of the conveyor) can be formed. In addition, a flow channel in which the width increases in the x-axis positive direction (the travel direction of the conveyor) may be used. In this case, a flow channel in which the depth of the batter (liquid coating material) decreases in the x-axis positive direction (the travel direction of the conveyor) can be formed.

Next, the height of the liquid level of the batter 21 will be described. Here, the height of the liquid level of the batter 21 is merely an example of the height of the top surface of the liquid coating material from the conveyor 22. FIG. 9 shows an example where the liquid level of the batter is adjusted to be higher than the food product F. FIG. 10 shows an example where the liquid level of the batter is adjusted to be lower than the food product F. Both FIGS. 9 and 10 are cross-sectional views of the flow channel 2 taken along a x-y plane. In the drawings, the flow direction of the batter 21 and the travel direction of the conveyor 22 are the x-axis positive direction.

In FIG. 9, the height hₗ of the liquid level of the batter 21 is higher than the height h_{f} of the top end of the food product F from the conveyor 22. When the specific gravity of the food product F with respect to the batter is high, the entire food product F can be immersed in the batter as in a food product 70. In this case, since it is not necessary to pour the batter to the food product F from above, the second pouring device can be removed. However, the specific gravity of the food product F with respect to the batter is not necessarily high.

When the specific gravity of the food product F with respect to the batter is low, the food product F floats in the batter 21 as in a food product 71 in FIG. 9. When the flow of the batter 21 in the flow channel 2 is not uniform, there may be a case where the food product F cannot be conveyed at a desired speed.

In addition, when the flow of the batter is not uniform, the travel direction of the food product F varies such that the food product F may collide with the side wall 23a or another food product. The food product F may be deformed by floating or may be fractured. In addition, the food product 71 may be attached to the side wall 23a to block the flow channel 2. Food products that float may adhere to each other such that it is difficult to separate the food products. In this circumstances, it is difficult that a plurality of food products F may be arranged in the width direction of the conveyor 22 to improve the efficiency of the food coating step.

When the food product F floats in the batter, a uniform flow of the batter is present and the food product F is conveyed in a state where the food product F is supported by the batter that is flowing, misalignment is suppressed, and collision, deformation, fracture, attachment, and the like can be avoided.

From the viewpoint of securing the quality of the food product and increasing the efficiency of the food coating step, it is preferable that the food product F does not float in the batter (liquid coating material). In the food coating apparatus according to the invention, the height hₗ of the liquid level of the batter 21 (liquid coating material) is controlled based on the height h_{f} of the food product F that is coated, the density of the food product F, the volume of the food product F, the density of the batter, and the like. As in the example of FIG. 9, a liquid level sensor 29 (level sensor) may be provided on the side wall 23a of the flow channel 2 to measure the height hₗ of the liquid level of the batter 21 (liquid coating material). The method of the liquid level sensor to be used is not particularly limited. In addition, the height of the liquid level may be verified by visual inspection of a worker.

In FIG. 10, the height hₗ of the liquid level of the batter 21 is lower than the height h_{f} of the top end of the food product F from the conveyor 22. As long as a buoyant force B applied to the food product F in the y-axis positive direction satisfies the following Expression (1), the food product F does not float in the batter 21.

[Expression 1]

B=ρ_{b}V_{fb}g−ρ_{f}V_{f}g≤0 (1)

Here, ρ_{b} represents the density of the batter, ρ_{f} represents the density of the food product F, V_{fb} represents the volume of a portion of the food product F having a height lower than the liquid level hₗ of the batter, V_{f} represents the total volume of the food product, and g represents an acceleration of gravity. ρ_{f}V_{f}g corresponds to the gravity applied to the food product F in the y-axis negative direction. In the case of FIG. 10, V_{f}>V_{fb} is satisfied due to the relationship of h_{f}>hₗ. Therefore, the food product F is less likely to float as compared to the case of FIG. 9. A controller of the food coating apparatus 1 may control the height hₗ of the liquid level of the batter such that Expression (1) is satisfied.

The volume V_{fb} of the portion of the food product F having a height lower than the liquid level hₗ of the batter can be estimated, for example, by acquiring the product of the total volume V_{f} of the food product and hₗ/h_{f}. This calculation method is merely exemplary, and the value of V_{fb} may be acquired using another method. For example, a table that stores a relationship between hₗ and V_{fb} may be used, or the value of V_{fb} may be calculated by inputting hₗ as a function.

That is, the height of the liquid level (top surface) of the batter 21 (liquid coating material) from the conveyor 22 can be controlled such that a buoyant force applied from the batter 21 (liquid coating material) to the food product F is lower than a buoyant force required to float the bottom surface of the food product F from the conveyor 22. In addition, the height of the liquid level (top surface) of the batter 21 (liquid coating material) from the conveyor 22 may be controlled to be lower than the height of the top end of the food product F from the conveyor 22 such that the relationship of h_{f}>hₗ is satisfied, and may be further controlled such that the conditions of Expression (1) are satisfied.

The height of the liquid level (top surface) of the batter 21 (liquid coating material) from the conveyor 22 may be controlled by changing the amount of the batter 21 (liquid coating material) poured into the flow channel 2 per unit time or the moving speed of the conveyor 22 based on at least any one of a measured value of the level sensor 29 provided on the side wall 23a of the flow channel 2, the density of the batter 21 (liquid coating material), the density of the food product F, the volume of the food product F, and the height of the food product F such that the conditions of Expression (1) are satisfied. The amount of the batter 21 (liquid coating material) may be designated by volume or by mass.

The food products 72 and 73 in FIG. 10 satisfy Expression (1), and thus are conveyed in the x-axis positive direction in a state where the bottom surfaces thereof are in contact with the conveyor 22 without floating in the batter 21. Since h_{f}>hₗ, the top surface of the food product 72 is not immersed in the batter. However, the batter is poured from the pouring container 27 to the food product 73 positioned in the travel direction of the conveyor 22 from above. Therefore, the entire surface of the food product F including the top surface is coated with the batter (liquid coating material).

FIG. 11 shows an arrangement example of food products in the food coating apparatus. As in the example of FIG. 10, as long as the floating of the food product F can be prevented, a plurality of food products F can be arranged in the width direction of the flow channel 2 using the high-speed food putting device 10 as in the example of FIG. 11. The batter functions as a buffer for the food product F put from the food putting device 10. Therefore, the deformation or fracture of the food product F is not likely to occur unlike FIG. 4. By using the food coating apparatus according to the invention, food products can be arranged on the conveyor at a higher density than that in the related art.

FIG. 12 shows a configuration example of the food coating step according to the embodiment. FIG. 12 is a cross-sectional view showing the food putting device 10, the food coating apparatus 1, and a device 50 relating to the next step. In this case, the food putting device 10 is an example of the device relating to the previous step of the food coating step. The device 50 performs the next step of the food coating step.

FIG. 12 shows an example of a configuration of the food coating apparatus. Since wheels 5 are provided in a lower portion of the food coating apparatus 1 in FIG. 12, the food coating apparatus is movable. As a result, a change in the arrangement of the production line, a change in production step, and the like can be smoothly handled. The food coating apparatus 1 does not necessarily include a moving device such as wheels.

In the food coating apparatus 1 of FIG. 12, the large-sized batter bath 20 is provided over the entire area of the lower side of the flow channel 2. As a result, most of the batter that flows out from not only the downstream position of the flow channel 2 but also the bottom plate 23, the side walls 23a and 23b, and the like can be collected, and the installation environment of the apparatus can be maintained to be clean. The structure of the batter bath 20 in FIG. 12 is merely exemplary, and a batter bath having a structure different from the above-described structure may be used. The liquid coating material stored in the batter bath as in the first configuration example is used, the structure of the batter bath 20 in FIG. 12 is merely exemplary, and a batter bath having a structure different from the above-described structure may be used.

Next, the pipe device in the example of FIG. 12 will be described.

The batter stored in the batter bath 20 flows down from an opening 28 to a tank 31 through a pipe 30. The worker can perform a replacement or replenishment operation of the batter using the tank 31.

The tank 31 is connected to a pump 32 through a pipe 31a. The pump 32 has a function of pumping up the batter from the tank 31. The pump 32 can be used as an electric pump, but the kind of power to be used is not particularly limited. The pump 32 may be a turbo pump, a volumetric pump, or a special pump, and the structure and kind thereof are not particularly limited.

The batter that is pumped up by the pump 32 is conveyed to the upper portion of the food coating apparatus 1 through pipes 33 and 34. The pipe 34 is connected to the first nozzle 26 (first pouring device) and supplies the batter to the flow channel 2. The pipe 33 is connected to a second nozzle 33a and supplies the batter from above the pouring container 27 (second pouring device).

The pipe device of FIG. 12 is merely exemplary, and the batter may be supplied using a pipe device having a structure different from the above-described structure. In the example of FIG. 12, the batter is circulated by the pipe device. However, the batter may not be circulated, the batter that has flown through the flow channel 2 may be disposed, and a new batter may be supplied to the first pouring device and the second pouring device. In addition, the pipe device may have a configuration in which a part of the batter is disposed, the remaining batter is circulated, and a new batter is replenished by an amount corresponding to a decrease in the amount of the batter.

Next, the conveyance device in the example of FIG. 12 will be described.

The conveyor 22 may be driven by the power of an electric motor 24. The power of the electric motor 24 is transmitted to a belt 25. The electric motor 24 and the belt 25 are an example of the drive device that drives the conveyor 22. The conveyor 22 travels in the x-axis positive direction along the bottom of the flow channel 2 and moves from an intermediate section with a rising slope. The section of the conveyor 22 that rises with a slope corresponds to the above-described section 22a. Once the conveyor 22 reaches an end portion 22b, the conveyor 22 is substantially horizontal again. At a terminal 22c, the travel direction of the conveyor switches from the x-axis positive direction to the x-axis negative direction. Once the food product F reaches the terminal 22c, the food product F is put on the device 50 relating to the next step provided in the lower portion. The conveyor of the food coating apparatus according to the invention is put in the next step in a state where a plurality of food products F are aligned. Therefore, the risk of the adherence between the food products F can be reduced.

The device 50 performs a cooking, processing, or packaging process on the food product F that is coated in the food coating apparatus 1. The device 50 may be a cooking device that performs a heating process, a cooling process, a drying process, another coating process, a breading process, a seasoning process, a flavoring process, or the like on the food product F. Examples of the heating process include grilling, boiling, and oil-frying, and any kind of heating process may be performed. In addition, the device 50 may be a processing device that performs a cutting process or the like on the food product F. In addition, the device 50 may accommodate the food product F in the container or may package the food product F. That is, the process that is performed by the device 50 is not particularly limited.

The food coating apparatus 1 of FIG. 12 includes a controller 40. For example, the controller 40 provides operation devices for the food coating apparatus 1 and displays the state. In addition, the controller 40 controls the moving speed of the conveyor 22, the height of the liquid level relating to the batter, the flow rate of the batter (liquid coating material), and the like. The liquid level sensor 29 provided on the side wall 23a is electrically connected to the controller 40. Accordingly, the controller 40 can execute the control process based on the measured value of the liquid level sensor 29. In the controller 40, a button, a switch, a touch panel, a lever, and the like may be provided as the operation devices. In addition, in order to display the state, a LED liquid crystal display, an organic electroluminescence display, or the like may be provided. The state display or the control process can be implemented with a program that operates on a central processing unit (CPU), a semiconductor circuit such as a FPGA or an ASIC, or a combination thereof.

Next, the control process of the liquid level hₗ of the batter in the flow channel 2 will be described. FIG. 13 shows an example of the process of controlling the height of the liquid level of the batter. The process of FIG. 13 is executed, for example, by the controller 40. Hereinafter, the process will be described with reference to the flowchart in FIG. 13. The height of the liquid level of the batter is an example of the height of the top surface of the liquid coating material.

Once the food coating apparatus 1 starts, the pump-up of the batter using the pump and the movement of the conveyor 22 are started. The flow rate of the batter in the flow channel 2 and the speed of the conveyor 22 are adjusted such that the height of the liquid level of the batter is equal to the set value hₗ (Step S101). The set value hₗ relating to the height of the liquid level can be set by the controller 40 such that Expression (1) is satisfied. The flow rate of the batter can be changed by adjusting the ejection amount of the pump 32 and the moving speed of the conveyor 22, for example. When a difference between the flow rate of the batter in the flow channel 2 and the speed of the conveyor 22 is small, a uniform flow is formed, and the misalignment of the food product F is reduced. Therefore, it is preferable that the flow rate of the batter in the flow channel 2 is close to the speed of the conveyor.

When the first configuration example is used, the height hₗ of the liquid level (the top surface of the liquid coating material) of the batter may be adjusted by changing the amount of the batter stored in the batter bath. In addition, as long as the flow channel is movably supported, the height hₗ may be adjusted by changing the height of the flow channel relative to the batter bath.

Next, the food putting device starts to put the food product F (Step S102). The arrangement position or arrangement method of the food products F are as described above in FIGS. 5 and 6. The controller 40 of the food coating apparatus 1 may transmit an operation start instruction to the food putting device 10, or another device may transmit the operation start instruction.

Once the food product F starts to be put, the controller 40 acquires the latest set value h′ₗ of the liquid level (Step S103). When a user changes the set value of the liquid level, this change can be detected in Step S103. The controller 40 checks whether or not a current height h_{c} of the liquid level is equal to the latest set value h′ₗ of the liquid level (Step S104). The controller 40 can acquire the current height h_{c} of the liquid level from the liquid level sensor 29. In Step S104, the process is branched based on the determination result.

In Step S104, when the controller 40 verifies that h_{c}=h′ₗ, the controller 40 executes Step S103 again after a predetermined period of time. Here, the predetermined period of time may be, for example, 30 seconds or 1 minute and may be different from the above-described example. When h_{c}≠h′ₗ in the determination of Step S104, the controller 40 proceeds to the next Step S105.

In Step S105, the controller 40 checks whether or not the current height h_{c} of the liquid level is higher than the latest set value h′ₗ of the liquid level. When the current height h_{c} of the liquid level is higher than the latest set value h′ₗ of the liquid level, the controller 40 executes a process of decreasing the liquid level of the batter in the flow channel (Step S106). In the second configuration example, the controller 40 may execute at least one of a control of reducing the ejection amount of the pump 32 or a control of increasing the moving speed of the conveyor. When the first configuration example is used, the controller 40 may execute at least one of a control of reducing the amount of the batter stored in the batter bath or a control of increasing the height of the flow channel relative to the batter bath.

On the other hand, when the current height h_{c} of the liquid level is lower than the latest set value h′ₗ of the liquid level, the controller 40 executes a process of increasing the liquid level of the batter in the flow channel (Step S107). In the second configuration example, the controller 40 may execute at least one of a control of increasing the ejection amount of the pump 32 or a control of reducing the moving speed of the conveyor 22. When the first configuration example is used, the controller 40 may execute at least one of a control of increasing the amount of the batter stored in the batter bath or a control of reducing the height of the flow channel relative to the batter bath.

Once the process of Step S106 or step S107 is executed, the controller 40 checks whether or not the production line of the food product is working (Step S108). The operation state of the food production line can be determined, for example, by checking whether or not the food product F put on the conveyor 22 remains. When the production line of the food product is working, the controller 40 executes Step S103 again after a predetermined period of time. When the operation of the production line of the food product is stopped, the pump-up of the batter using the pump 32 and the movement of the conveyor 22 are stopped (Step S109). The operation of stopping the conveyor 22 may be manually performed by visual inspection of the worker.

In FIG. 13, the check process in Step S108 is executed in the latter stage of the flowchart but may be executed at a different timing from the above-described timing. For example, the check process in Step S108 may be executed at any timing of Step S103 to Step S105.

By performing the process shown in the flowchart in FIG. 13, the height of the liquid level of the batter (liquid coating material) can be adjusted such that the food product F does not float. In addition, once the size or density of the food product to be coated is changed, the height of the liquid level of the batter (liquid coating material) can be changed according to the change.

### Second Embodiment

The flow channel in the food coating apparatus according to the first embodiment is substantially horizontal. However, a flow channel with a slope may be used. In a food coating apparatus according to a second embodiment, a falling slope in the travel direction of the flow channel is provided. Hereinafter, a difference from that of the first embodiment will be mainly described.

FIG. 14 shows an example of the flow channel according to the second embodiment. FIG. 14 is a cross-sectional view of a flow channel 2a taken along a x-y plane. A horizontal line 80 of FIG. 14 is parallel to the x-axis and indicates the height of the upstream position of the flow channel 2a. The height of the flow channel 2a in the y-axis direction decreases in the x-axis positive direction (travel direction). Accordingly, it can be seen that the flow channel 2a is provided with a falling slope from the upstream position to the downstream position.

In the example of FIG. 14, the flow channel 2a is provided with a falling slope having about one degree with respect to the horizontal direction. As a result, the food coating step can be performed using the liquid coating material that is not likely to flow due to a high viscosity. This slope angle is merely exemplary, and the flow channel 2a may be provided with a slope having a different angle from the above-described angle.

In FIG. 14, the flow channel 2a is provided with a falling slope from the upstream position to the downstream position but conversely may be provided with a rising slope from the upstream position to the downstream position. The slope in the flow channel 2a is not particularly limited. By mounting the rotation mechanism, the lift mechanism, or the like, the slope of the flow channel 2a in the food coating apparatus may be configured to be adjusted. As a result, the food product can be coated using the liquid coating material having various physical properties.

### Third Embodiment

In each of the above-described embodiments, the conveyance of the food product in the flow channel and the conveyance of the food product between the flow channel and the next step are also implemented using a series of conveyor. In the food coating apparatus according to the invention, the conveyance of the food product is not necessarily conveyed by a series of conveyor.

FIG. 15 shows an example of a food coating apparatus according to the third embodiment. Hereinafter, a difference from each of the embodiments will be mainly described with reference to FIG. 15.

The food coating apparatus according to the embodiment includes a plurality of conveyors. The conveyor 22 conveys the food product F in the x-axis positive direction of the flow channel 2 and is terminated at the downstream position of the flow channel 2 that is the edge portion 61 of the bottom plate 23. A starting end of another conveyor 36 may be positioned with a gap 35 from the terminal of the conveyor 22 in the x-axis positive direction.

The width of the gap 35 in the x-axis positive direction is suppressed to a size such that the food product F is prevented from falling down to the batter bath 20 and the food product F that is being conveyed is prevented from being interposed between the terminal of the conveyor 22 and the starting end of the conveyor 36. On the other hand, the width of the gap 35 in the x-axis positive direction is sufficiently secured such that the batter flows down from the downstream position (the edge portion 61 of the bottom plate 23) of the flow channel 2 to the batter bath 20.

The food product F that is conveyed up to the downstream position (the edge portion 61 of the bottom plate 23) of the flow channel 2 by the conveyor 22 is received by the conveyor 36 and is conveyed in the x-axis positive direction. That is, the food product F is conveyed by the conveyor 22 in the section in the flow channel. However, after passing through the flow channel, the food product F is conveyed by the conveyor 36 in the section up to the next step. In the example of FIG. 15, the conveyor 36 conveys the food product F in the x-axis positive direction but may convey the food product F in a direction different from the x-axis positive direction.

In order to convey the food product F in the section up to the next step, a conveyance device other than the conveyor may be used. For example, the food product F that is conveyed up to the downstream position of the flow channel 2 may be lifted by a robot hand to convey the food product F to the device relating to the next step. The worker may manually move the food product F without providing the device that automatically conveys the food product F in the section from the downstream position of the flow channel 2 to the next step.

As in the embodiment, the batter easily flows down from the downstream position of the flow channel 2 by providing the gap 35 between the conveyor 22 of the flow channel 2 and the device (for example, the conveyor 36) that conveys the food product F up to the next step. As a result, the attachment of the batter to the conveyance device in the next stage can be reduced. In addition, by using the configuration as in the example of FIG. 15, even when a rubber belt not having a mesh is used as the conveyor 22, a decrease in the flow rate of the batter or the attachment of the batter to the conveyance device in the next stage is not likely to occur.

### Fourth Embodiment

In the second pouring device of FIGS. 5 and 6, the batter (liquid coating material) is poured in a section where the conveyor is provided in the flow channel 2. However, the second pouring device does not necessarily pour the batter (liquid coating material) in the section where the conveyor is provided in the flow channel 2. The second pouring device according to the fourth embodiment pours the batter (liquid coating material) at a position of the conveyor in the x-axis positive direction with respect to the downstream position of the flow channel 2.

FIG. 16 shows an example of the food coating apparatus according to the fourth embodiment. In the food coating apparatus of FIG. 16, the second pouring device including the pouring container 27 and the second nozzle 33a through which the batter (liquid coating material) is poured to the pouring container 27 is positioned at a position in the x-axis positive direction (the travel direction of the conveyor) with respect to the example of FIG. 15.

The batter (liquid coating material) that flows out from the pouring container 27 is poured to the lower region where the conveyor 36 is provided. When the conveyor 36 is a net conveyor having a mesh shape, as in the example of FIG. 16, the poured batter (liquid coating material) flows down from a net (opening) of the conveyor 36 and is collected by the batter bath 20 positioned below (y-axis negative direction) the conveyor 36.

When the food product F is conveyed by the conveyor 36, the batter (liquid coating material) that flows out from the pouring container 27 to the food product F is poured from above the food product F. When the food product F is put from the putting device to the putting position where the conveyor 22 is immersed in the batter (liquid coating material), a part of the surface of the food product F including at least the bottom surface is coated with the batter (liquid coating material). The remaining region on the surface of the food product F is coated with the batter (liquid coating material) that flows out from the pouring container 27. This way, when the batter (liquid coating material) is poured to the food product at a position of the conveyor in the x-axis positive direction with respect to the downstream position of the flow channel 2, the entire surface of the food product can be coated.

In the example of FIG. 16, the conveyor (conveyor 22) in the flow channel and the conveyor (conveyor 36) for the conveyance to the next step are separated from each other. However, the conveyance may be performed by a series of conveyor. In addition, the second pouring device in FIG. 16 is merely exemplary. Accordingly, the shape or structure of the second pouring device may be different from that of the example of FIG. 16. In addition, the number of times the second pouring device pours the batter (liquid coating material) to the conveyor is not particularly limited.

The structures or functions of the other components in the food coating apparatus according to the embodiment are the same as those of each of the above-described embodiments.

This way, by using the food coating apparatus according to the invention, a plurality of problems in the food coating step can be solved. In the food coating apparatus according to the invention, an impact applied when the food product is put is reduced, and the deformation or fracture of the food product can be prevented. Since the batter is present on the conveyor, the risk of the attachment of the bottom surface of the food product to the conveyor is also reduced.

In addition, in the food coating apparatus according to the invention, the flow of the batter (liquid coating material) is controlled such that a uniform flow is formed in the flow channel. Therefore, the occurrence of problems caused by the misalignment of the food product is prevented. Specifically, the attachment of the food product to the wall surface and the adherence between food products can be prevented such that a high-density arrangement of the food products can be implemented. As a result, the food product can be efficiently coated, and the high-speed food putting device can be provided in the previous step. This way, by using the food coating apparatus according to the invention, deterioration in the quality of the food product or food material loss can be reduced, and food products that are difficult to handle in the coating step of the related art, for example, a food product having a high water content, a food product having bubbles, a food product having a cavity, an easily-crumbled food product having low adhesiveness, or a food product having a strong viscosity can be coated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

F, 70, 71: food product
1: food coating apparatus
2, 2a: flow channel
3: conveyance device
4: pipe device
5: wheel
10: food putting device
10a: putting position
20: batter bath
20c, 22; conveyor
22a: section
21: batter
22b: end portion
22c: terminal
23: bottom plate
23a, 23b: side wall
27a, 27b: opening
24: electric motor
25: belt
26: first nozzle
27: pouring container
28: opening
29: liquid level sensor (level sensor)
30, 31a, 33, 34: pipe
31: tank
32: pump
33a: second nozzle
40: controller
50: device
61: edge portion
62: holder
80: horizontal line

1. A food coating apparatus comprising:
a flow channel through which a liquid coating material flows;
a conveyor to be immersed in the liquid coating material and to make the liquid coating material to flow in a travel direction, the conveyor being arranged on an upper side of a bottom surface of the flow channel;
a drive device configured to drive the conveyor; and
a putting device configured to put a food product,
wherein the conveyor is immersed in the liquid coating material at a putting position where the putting device puts the food product, and
the food product is conveyed and coated with the liquid coating material in the flow channel in a state where the food product is supported by the conveyor or is supported by the liquid coating material that is flowing.

2. The food coating apparatus according to claim 1, further comprising a first pouring device configured to pour the liquid coating material into the flow channel at a position positioned in a direction opposite to the travel direction of the conveyor with respect to the putting position.

3. The food coating apparatus according to claim 1, further comprising a second pouring device configured to pour the liquid coating material from above the conveyor at a position positioned in the travel direction of the conveyor with respect to the putting position.

4. The food coating apparatus according to claim 3, wherein in the second pouring device, the liquid coating material stored in a container is poured from a first opening and a second opening, the first opening being provided in the container, and the second opening being provided in the travel direction of the conveyor with respect to the first opening of the container.

5. The food coating apparatus according to claim 1, further comprising a circulation mechanism configured to make the liquid coating material flow in a direction opposite to the travel direction of the conveyor.

6. The food coating apparatus according to claim 1, further comprising:
a first pouring device configured to pour the liquid coating material into the flow channel at a position positioned in a direction opposite to the travel direction of the conveyor with respect to the putting position;
a second pouring device configured to pour the liquid coating material from above the conveyor at a position positioned in the travel direction of the conveyor with respect to the putting position; and
a circulation mechanism configured to make the liquid coating material flow in a direction opposite to the travel direction of the conveyor and to supply the liquid coating material to at least one of the first pouring device or the second pouring device.

7. The food coating apparatus according to claim 1, wherein the putting device is a molding machine.

8. A food production method comprising:
driving a conveyor immersed in a liquid coating material and making the liquid coating material flow in a travel direction of the conveyor in a flow channel through which the liquid coating material flows;
putting a food product on the liquid coating material in which the conveyor is immersed; and
conveying and coating the food product with the liquid coating material in the flow channel in a state where the food product is supported by the conveyor or is supported by the liquid coating material that is flowing.

9. The food production method according to claim 8, further comprising controlling a height of a top surface of the liquid coating material from the conveyor such that a buoyant force applied from the liquid coating material to the food product is lower than a buoyant force required to float a bottom surface of the food product from the conveyor.

10. The food production method according to claim 8, further comprising controlling a height of a top surface of the liquid coating material from the conveyor to be lower than a height of a top end of the food product from the conveyor.

11. The food production method according to claim 8, further comprising controlling a height of an top surface of the liquid coating material from the conveyor by changing at least an amount of the liquid coating material poured into the flow channel per unit time or a moving speed of the conveyor based on any one of a measured value of a level sensor provided on a side wall of the flow channel, a density of the liquid coating material, a density of the food product, a volume of the food product, or a height of the food product.

12. The food production method according to claim 8, further comprising pouring the liquid coating material into the flow channel at a position in a direction opposite to the travel direction of the conveyor with respect to a position of the flow channel where the food product is arranged.
